(19) United States
(12) Patent Application Publication
(10) Pub. No.: US 2020/0036987 A1
(43) Pub. Date: Jan. 30, 2020

(54) CONTEXT REDUCTION OF SIGNIFICANCE MAP CODING OF 4 X 4 AND 8 X 8 TRANSFORM COEFFICIENT IN HM4.0

(71) Applicant: SONY CORPORATION, TOKYO (JP)

(72) Inventors: CHEUNG AUYEUNG, SUNNYVALE, CA (US); JUN XU, SUNNYVALE, CA (US)

(21) Appl. No.: 16/594,496

(22) Filed: Oct. 7, 2019

Related U.S. Application Data
(63) Continuation of application No. 13/654,134, filed on Oct. 17, 2012.
(60) Provisional application No. 61/548,830, filed on Oct. 19, 2011.

(51) Int. Cl. H04N 19/18; H04N 19/13; H04N 19/91; H04N 19/157

(52) U.S. Cl. CPC H04N 19/18; H04N 19/157; H04N 19/91; H04N 19/13

(57) ABSTRACT

Reducing contexts of a significance map includes merging some of the adjacent partitions of the higher frequency transform coefficients into one partition so that the significance of the coefficients in a merged partition are encoded with the same contexts. To reduce the impact of merging on coding efficiency of 4×4 blocks, the partitions of the lower frequency AC components of 4×4 blocks are not merged. To reduce the impact of merging on coding efficiency, the DC component is not merged with any AC component.

### CROSS-REFERENCE TO RELATED APPLICATIONS

The present application is a continuation application of U.S. patent application Ser. No. 13/654,134, filed Oct. 17, 2012, which claims the benefit of priority from the U.S. Provisional Patent Application Ser. No. 61/548,830, filed Oct. 19, 2011, the entire content of which is hereby incorporated by reference.

### FIELD OF THE INVENTION

The present invention relates to the field of image processing. More specifically, the present invention relates to high efficiency video coding.

### BACKGROUND OF THE INVENTION

High Efficiency Video Coding (HEVC), also known as H.265 and MPEG-H Part 2, is a draft video compression standard, a successor to H.264/MPEG-4 AVC (Advanced Video Coding), currently under joint development by the ISO/IEC Moving Picture Experts Group (MPEG) and ITU-T Video Coding Experts Group (VCEG). MPEG and VCEG have established a Joint Collaborative Team on Video Coding (JCT-VC) to develop the HEVC standard. HEVC improves video quality and double the data compression ratio compared to H.264, and scales from 320 □240 to 7680□4320 pixels resolution.

### SUMMARY OF THE INVENTION

Reducing contexts of a significance map includes merging some of the adjacent partitions of the higher frequency transform coefficients into one partition so that the significance of the coefficients in a merged partition are encoded with the same contexts. To reduce the impact of merging on coding efficiency, the partitions of the lower frequency components of the 4×4 significance map are not merged, and the DC component of any significance map is not merged with any AC components.

In one aspect, a method of implementing context reduction programmed in a device comprises merging one or more partitions of high frequency transform coefficients and splitting a lowest frequency partition. The one or more partitions are adjacent. The lowest frequency partition contains a DC component. The DC component is extracted into a partition with a context separated from any AC components. Low frequency AC coefficients of 4×4 blocks are not merged. The DC coefficients are not merged with any AC coefficients. Context reduction occurs in at least one of 4×4 or 8×8 blocks. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

In another aspect, a method of implementing context reduction programmed in a device comprises merging one or more partitions of high frequency transform coefficients in significance maps of at least one of 4×4 blocks or 8×8 blocks and splitting a lowest frequency partition. The one or more partitions are adjacent. The lowest frequency partition contains a DC component. The DC component is extracted into a partition with a context separated from any AC components. Low frequency AC coefficients of 4×4 blocks are not merged. The DC coefficient is not merged with any AC coefficient. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

In another aspect, an apparatus comprises a non-transitory memory for storing an application, the application for merging one or more partitions of high frequency transform coefficients and splitting a lowest frequency partition from higher frequency transform coefficients and a processing component coupled to the memory, the processing component configured for processing the application. The one or more partitions are adjacent. The lowest frequency partition contains a DC component. The DC component is extracted into a partition with a context different from any AC components. Low frequency AC coefficients of 4×4 blocks are not merged. The DC coefficient is not merged with any AC coefficients. Context reduction occurs in at least one of 4×4 or 8×8 blocks. The apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

### BRIEF DESCRIPTION OF THE DRAWINGS

FIG. 1 illustrates a diagram of context assignment of a 4×4 significance map coding with CABAC according to some embodiments.

FIG. 2 illustrates a diagram of context assignment of a 4×4 significance map coding with CABAC according to some embodiments.

FIG. 3 illustrates a diagram of context assignment of an 8×8 significance map coding with CABAC according to some embodiments.

FIG. 4 illustrates a diagram of context assignment of an 8×8 significance map coding with CABAC according to some embodiments.

FIG. 5 illustrates a diagram of context assignment of 16×16 and 32×32 significance map coding with CABAC according to some embodiments.

FIG. 6 illustrates a flowchart of a method of implementing context reduction according to some embodiments.

FIG. 7 illustrates a block diagram of an exemplary computing device configured to implement the context reduction method according to some embodiments.

### DETAILED DESCRIPTION OF THE PREFERRED EMBODIMENT

In High Efficiency Video Coding (HEVC) Test Model 4.0 with Context-Adaptive Binary Arithmetic Coding (CABAC), the significance map of the 4×4 and 8×8 transform coefficients are partitioned uniformly into 4×4 partitions. The significance of the transform coefficients in the same partition are encoded with the same contexts with CABAC, and the significance of the coefficients in different partitions are encoded with different contexts.

The number of contexts are reduced by merging some of the adjacent partitions of the higher frequency transform coefficients into one partition so that the significance of the coefficients in a merged partition are encoded with the same contexts. To further reduce the number of contexts, more and more higher partitions are merged into one partition as the frequency increases. To reduce the impact of merging on coding efficiency of 4×4 blocks, the partitions of the lower AC frequency components of 4×4 blocks are not merged. In general, the DC component of any block is not merged with any AC component.

Merging of partitions into one partition could reduce the overall coding efficiency. To compensate the reduction of coding efficiency of an 8×8 significance map due to merging, the lowest frequency partition is split, which contains the DC component, into two partitions by extracting the DC component into a separate partition within its own separate context.

As a result of the merging and splitting, the significance map of the 4×4 and 8×8 transform coefficients are partitioned non-uniformly, the number of contexts is reduced, and the impact of coding efficiency is minimized.

For the coding of the significant_coeff_flag of the transform coefficients with CABAC, HM4 has 30 contexts for 4×4 transform blocks, 32 contexts for 8×8 transform blocks, and 26 contexts for 16×16 and 32×32 blocks for a total of 88 contexts.

The context reduction described herein reduces the 88 contexts by 24 contexts with 0.0% average BD-Rate for all test cases.

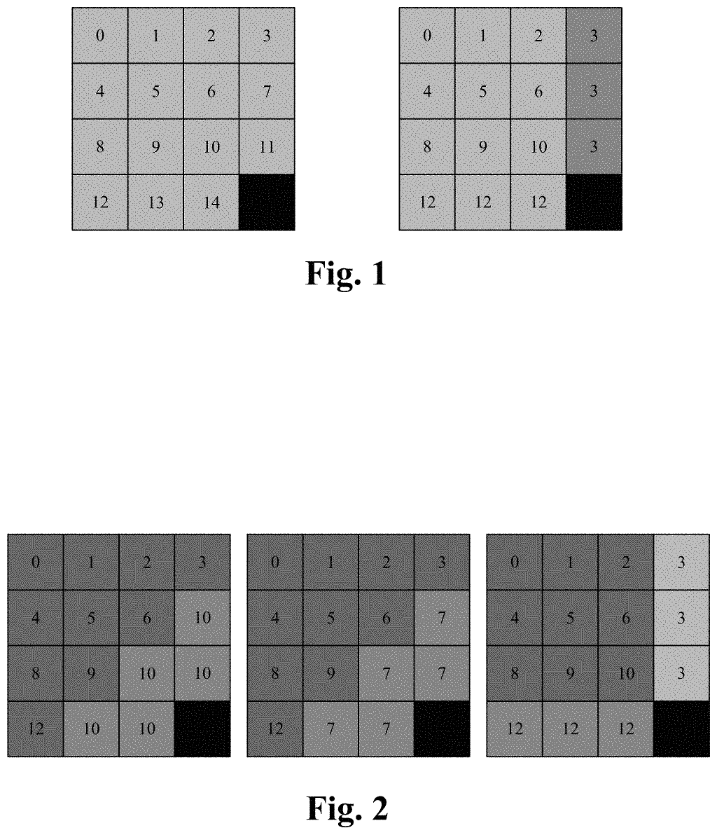

HM4 has 15 contexts for coding the significant_coeff_flag of a 4×4 luminance block. To reduce the number of contexts, contexts are merged, for example, as shown in FIG. 1. In particular, the contexts with index 3, 7 and 11 are merged to the context with index 3. The contexts with index 12, 13 and 14 are merged to the context with index 12. By merging contexts, 4 luminance and 4 chrominance contexts are reduced. FIG. 2 shows context assignments of a 4×4 significance map coding with CABAC according to some embodiments.

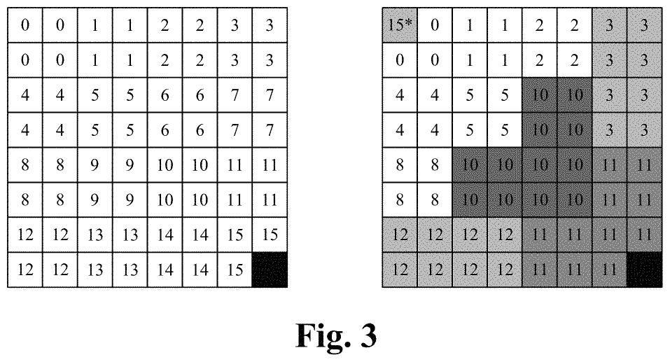

HM4 has 16 contexts for coding the significant_coeff_flag of an 8×8 luminance block. To reduce the number of contexts, some of the contexts are merged, for example as shown in FIG. 3. The contexts 6, 9 and 10 are merged to context 10. The contexts 12 and 13 are merged to context 12. The contexts 11, 14 and 15 are merged to context 11.

In HM4, the lower 4 frequency components shared the same context 0. To improve coding efficiency, the DC component is split from the context 0, so that the DC component has a separate context 15*. The context 15* reuses the context 15 but with the same context initialization as context 0.

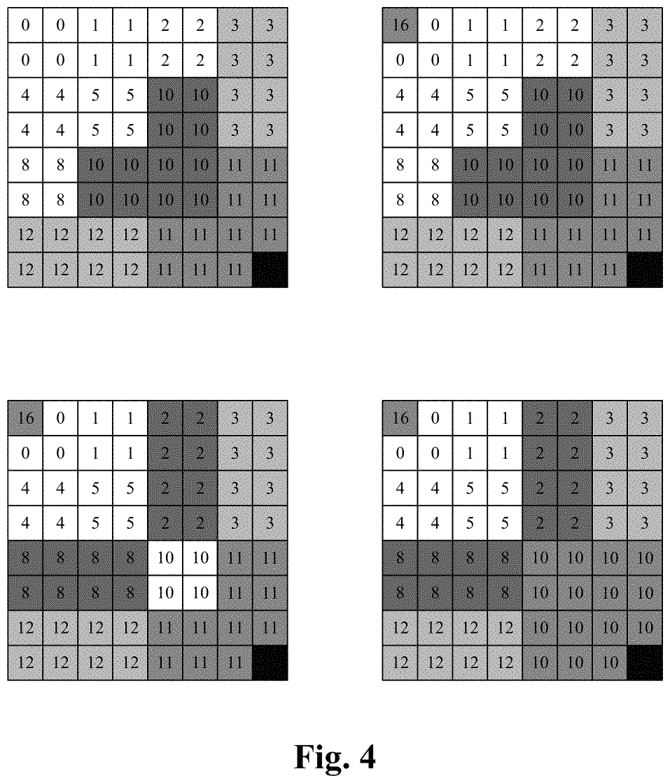

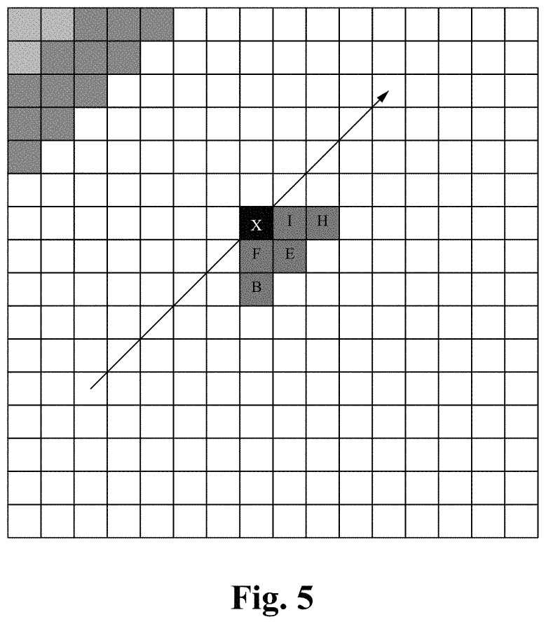

By merging and splitting contexts, 5 contexts are reduced for the 8×8 luminance block, and 5 contexts are reduced for the 8×8 chrominance block. FIG. 4 shows context assignment of an 8×8 significance map coding with CABAC according to some embodiments.

As shown in FIG. 5, HM4 divides the significance map of 16×16 and 32×32 in three regions: light gray region, dark gray region and white region. The light gray region includes the positions with xC+yC<2. The dark gray region includes the positions with 2□xC+yC<5. The white region includes the positions with 5□xC+yC.

In HM4, each position in the light gray region has its own context. The light gray region has a total of 3 contexts for the luminance 16×16 and 32×32 blocks. To determine the context for the significant_coeff_flag at position (xC, yC) in the dark gray and white regions, let:
significant_coeff_flag[i][j]=0, if (i,j) is outside the transform block
   and let:
I=significant_coeff_flag[xC+1][yC]
H=significant_coeff_flag[xC+2][yC]
F=significant_coeff_flag[xC][yC+1]
E=significant_coeff_flag[xC+1][yC+1]
B=significant_coeff_flag[xC][yC+2]

The context increment of the significant_coeff_flag[xC][yC] in the dark gray region is
ctxInc=min(4, I+H+F+E+B)

Therefore, the dark gray region has 5 contexts for the luminance block. The context increment of significant_coeff_flag[xC][yC] in the white region is derived as follows:

### If (I+H+F+E)<4

ctxInc=I+H+F+E+B
   else
ctxInc=l+H+F+E

Therefore, the white region has 5 contexts for the luminance block.

To reduce the number of contexts for the coding of significance map of 16×16 and 32×32 transform blocks, the context increment in the light gray region is determined as follows:

Int map[ ]={0, 1, 1, 3, 3, 3}
ctxInc=map[I+H+F+E+B]
In the white region, contexts are reduced from 5 to 4:
Int map={0, 1, 2, 3, 3, 3};
ctxInc=map[I+H+F+E+B]

Therefore, the dark gray region has 3 contexts for the luminance block and a reduction of 2 luminance contexts and 2 chrominance contexts. The context increment in the dark gray region is determined as

ctxInc=min (3, I+H+F+E+B)

Therefore, the white region has 4 contexts for the luminance block and a reduction of 1 luminance context and 1 chrominance context.

The context reductions were integrated into HM4.0. The simulations were performed in three Microsoft HPC clusters. All intra simulations are performed on AMD Opteron Processor 6136 cluster @ 2.4 GHz. All RA simulations are performed on Intel Xeon X5690 cluster @ 3.47 GHz. All LD simulations are performed on Intel Xeon X5680 cluster @ 3.33 GHz. As shown in Table 1, the 25 context reduction for the coding of the significance map resulted in average BD-Rate of 0.0% for all test cases.

TABLE 1
Context reduction of 24 contexts resulted in an average BD-Rate of 0.0% for all tests cases.

| | All Intra | | | All Intra | | | All Intra | | |
|---|---|---|---|---|---|---|---|---|---|
| | HE | | | (Low QP) | | | (RDOQ off) | | |
| | Y | U | V | Y | U | V | Y | U | V |
| Class A | 0.02% | 0.00% | 0.04% | 0.02% | — | — | 0.01% | 0.10% | 0.07% |
| Class B | 0.04% | 0.03% | 0.05% | 0.10% | 0.01% | 0.02% | 0.00% | 0.04% | 0.09% |
| Class C | 0.01% | 0.01% | — | 0.02% | 0.06% | 0.07% | — | — | 0.01% |
| Class D | 0.00% | — | 0.01% | 0.00% | 0.04% | 0.04% | 0.04% | 0.02% | — |
| Class E | 0.03% | 0.03% | — | 0.05% | — | — | — | — | 0.04% |
| Class F | | 0.04% | 0.03% | | 0.01% | 0.02% | 0.06% | 0.04% | 0.12% |
| | | | 0.01% | | — | — | 0.01% | 0.15% | |
| | | | | | 0.06% | 0.02% | | | |
| Overall | 0.02% | 0.01% | 0.01% | 0.04% | 0.01% | 0.02% | — | 0.04% | 0.05% |
| | 0.02% | 0.01% | 0.02% | 0.04% | 0.00% | 0.01% | 0.02% | 0.04% | 0.04% |
| | | | | | | | — | | |
| | | | | | | | 0.02% | | |
| Enc | | 101% | | | 102% | | | 100% | |
| Time[%] | | 100% | | | 100% | | | 101% | |
| Dec | | | | | | | | | |
| Time[%] | | | | | | | | | |
| | Random Access | | | Random Access | | | Random Access | | |
| | HE | | | (Low QP) | | | (RDOQ off) | | |
| | Y | U | V | Y | U | V | Y | U | V |
| Class A | 0.03% | — | 0.06% | 0.02% | 0.01% | 0.03% | — | — | — |
| Class B | 0.00% | 0.06% | 0.16% | 0.05% | 0.06% | — | 0.01% | 0.03% | 0.01% |
| Class C | — | 0.19% | 0.00% | — | 0.00% | 0.03% | 0.01% | 0.01% | — |
| Class D | 0.02% | — | 0.02% | 0.02% | — | 0.02% | — | — | 0.01% |
| Class E | 0.02% | 0.09% | | — | 0.10% | — | 0.03% | 0.12% | 0.04% |
| Class F | | — | | 0.02% | | 0.11% | — | 0.07% | — |
| | | 0.08% | | | | | 0.10% | | 0.10% |
| Overall | 0.01% | 0.00% | 0.06% | 0.01% | 0.00% | — | — | — | — |
| | 0.01% | — | 0.07% | 0.01% | — | 0.02% | 0.03% | 0.02% | 0.02% |
| | | 0.04% | | | 0.02% | — | — | — | — |
| | | | | | | 0.01% | 0.03% | 0.02% | 0.02% |
| Enc | | 101% | | | 102% | | | 101% | |
| Time[%] | | 100% | | | 101% | | | 101% | |
| Dec | | | | | | | | | |
| Time[%] | | | | | | | | | |
| | Low delay B | | | Low delay B | | | Low delay B | | |
| | HE | | | (Low QP) | | | (RDOQ off) | | |
| | Y | U | V | Y | U | V | Y | U | V |
| Class A | 0.02% | — | — | 0.04% | 0.00% | — | — | — | — |
| Class B | 0.03% | 0.07% | 0.16% | — | — | 0.03% | 0.02% | 0.00% | 0.09% |
| Class C | — | — | — | 0.02% | 0.14% | — | — | 0.28% | 0.14% |
| Class D | 0.03% | 0.01% | 0.24% | — | — | 0.14% | 0.01% | 0.03% | — |
| Class E | 0.12% | 0.11% | — | 0.05% | 0.27% | — | — | — | 0.17% |
| Class F | | — | 0.42% | 0.03% | — | 0.14% | 0.01% | 0.50% | — |
| | | 1.01% | 0.97% | | 0.77% | — | — | | 0.64% |
| | | | | | | 0.08% | 0.08% | | |
| Overall | 0.03% | — | — | 0.00% | — | — | — | — | — |
| | 0.03% | 0.19% | 0.03% | 0.00% | 0.24% | 0.10% | 0.03% | 0.02% | 0.15% |
| | | — | — | | — | — | — | 0.02% | — |
| | | 0.20% | 0.05% | | 0.27% | 0.12% | 0.03% | | 0.16% |
| Enc Time | | 101% | | | 102% | | | 100% | |
| [%] | | 101% | | | 102% | | | 101% | |
| Dec Time | | | | | | | | | |
| [%] | | | | | | | | | |

The reduced 24 contexts for the coding of significance map with CABAC and resulted in average luminance BD-Rate of 0.0% for all test cases in Table 1.

TABLE 2
Average BD-Rate of 24 significance map context reduction.

| | I_HE | RA_HE | LD_HE |
|---|---|---|---|
| QP(22, 27, 32, 37) | 0.02 | 0.01 | 0.03 |
| LQP(12, 17, 22, 27) | 0.04 | 0.01 | 0.00 |
| RDOQ-OFF | −0.02 | −0.03 | −0.03 |

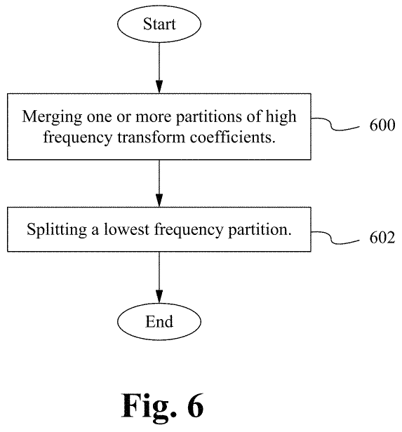

FIG. 6 illustrates a flowchart of a method of implementing context reduction according to some embodiments. In the step 600, one or more partitions of high frequency transform coefficients are merged. In the step 602, a lowest frequency partition is split. In some embodiments, more or fewer steps are implemented. In some embodiments, the order of the steps is modified.

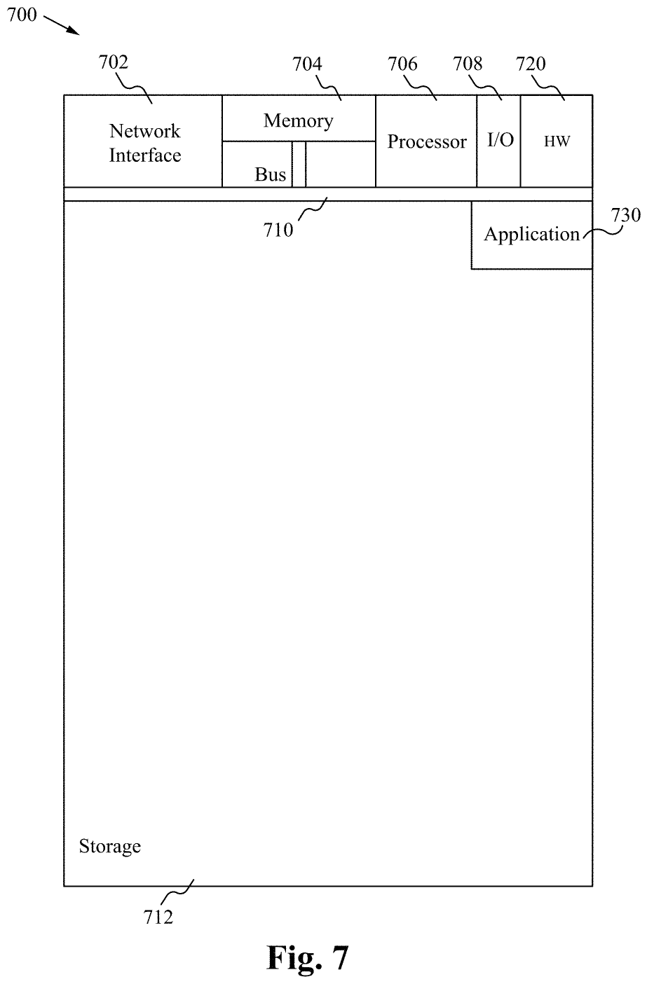

FIG. 7 illustrates a block diagram of an exemplary computing device configured to implement the context reduction method according to some embodiments. The computing device 700 is able to be used to acquire, store, compute, process, communicate and/or display information such as images, videos and audio. For example, a computing device 700 is able to be used to acquire and store a video. The context reduction method is typically used during or after acquiring a video. In general, a hardware structure suitable for implementing the computing device 700 includes a network interface 702, a memory 704, a processor 706, I/O device(s) 708, a bus 710 and a storage device 712. The choice of processor is not critical as long as a suitable processor with sufficient speed is chosen. The memory 704 is able to be any conventional computer memory known in the art. The storage device 712 is able to include a hard drive, CDROM, CDRW, DVD, DVDRW, Blu-Ray®, flash memory card or any other storage device. The computing device 700 is able to include one or more network interfaces 702. An example of a network interface includes a network card connected to an Ethernet or other type of LAN. The I/O device(s) 708 are able to include one or more of the following: keyboard, mouse, monitor, display, printer, modem, touchscreen, button interface and other devices. In some embodiments, the hardware structure includes multiple processors and other hardware to perform parallel processing. Context reduction application(s) 730 used to perform the context reduction method are likely to be stored in the storage device 712 and memory 704 and processed as applications are typically processed. More or fewer components shown in FIG. 7 are able to be included in the computing device 700. In some embodiments, context reduction hardware 720 is included. Although the computing device 700 in FIG. 7 includes applications 730 and hardware 720 for implementing the context reduction method, the context reduction method is able to be implemented on a computing device in hardware, firmware, software or any combination thereof. For example, in some embodiments, the context reduction applications 730 are programmed in a memory and executed using a processor. In another example, in some embodiments, the context reduction hardware 720 is programmed hardware logic including gates specifically designed to implement the method.

In some embodiments, the context reduction application(s) 730 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone (e.g. an iPhone®), a smart appliance, a gaming console, a digital camera, a digital camcorder, a camera phone, a portable music device (e.g. an iPod®), a tablet computer (e.g. an iPad®), a video player, a DVD writer/player, a Blu-ray® writer/player, a television, a home entertainment system or any other suitable computing device.

To utilize the context reduction method, a device such as a digital camera is able to be used to acquire a video or image. The context reduction method is automatically used for performing image/video processing. The context reduction method is able to be implemented automatically without user involvement.

In operation, the context reduction method enables faster processing of information and reducing storage space requirements. Potential applications of this implementation include use with the HEVC codec.

### Some Embodiments of Context Reduction of Significance Map Coding of 4×4 and 8×8 Transform Coefficient in HM4.0

1. A method of implementing context reduction programmed in a device comprising:
   a. merging one or more partitions of high frequency transform coefficients; and
   b. splitting a lowest frequency partition.
2. The method of clause 1 wherein the one or more partitions are adjacent.
3. The method of clause 1 wherein the lowest frequency partition contains a DC component.
4. The method of clause 3 wherein the DC component is extracted into a partition with a context separated from any AC components.
5. The method of clause 1 wherein low frequency AC coefficients of 4×4 blocks are not merged.
6. The method of clause 1 wherein the DC coefficients are not merged with any AC coefficients.
7. The method of clause 1 wherein context reduction occurs in at least one of 4×4 or 8×8 blocks.
8. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.
9. A method of implementing context reduction programmed in a device comprising:
   a. merging one or more partitions of high frequency transform coefficients in significance maps of at least one of 4×4 blocks or 8×8 blocks; and
   b. splitting a lowest frequency partition.
10. The method of clause 9 wherein the one or more partitions are adjacent.
11. The method of clause 9 wherein the lowest frequency partition contains a DC component.
12. The method of clause 11 wherein the DC component is extracted into a partition with a context separated from any AC components.
13. The method of clause 9 wherein low frequency AC coefficients of 4×4 blocks are not merged.
14. The method of clause 9 wherein the DC coefficient is not merged with any AC coefficient.
15. The method of clause 9 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.
16. An apparatus comprising:
   a. a non-transitory memory for storing an application, the application for:
      i. merging one or more partitions of high frequency transform coefficients; and
      ii. splitting a lowest frequency partition from higher frequency transform coefficients; and
   b. a processing component coupled to the memory, the processing component configured for processing the application.
17. The apparatus of clause 16 wherein the one or more partitions are adjacent.
18. The apparatus of clause 16 wherein the lowest frequency partition contains a DC component.
19. The apparatus of clause 18 wherein the DC component is extracted into a partition with a context different from any AC components.
20. The apparatus of clause 16 wherein low frequency AC coefficients of 4×4 blocks are not merged.
21. The apparatus of clause 16 wherein the DC coefficient is not merged with any AC coefficients.
22. The apparatus of clause 16 wherein context reduction occurs in at least one of 4×4 or 8×8 blocks.
23. The apparatus of clause 16 wherein the apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A coding device, comprising:
a coding part configured to:
assign contexts, wherein the assigned contexts are split into:
at least one area for a coding process by each coding coefficient of a plurality of coding coefficients without share of a context for each coding coefficient, and
five areas for a coding process by merge of the plurality of coding coefficients with share of the context for each coding coefficient; and
apply a significance map coding process to a significance map to code coefficients of a block based on the assigned contexts.

2. The coding device according to claim 1, wherein
the at least one area is on an upper left side of the block which is a low frequency region including a DC component, and
the five areas consist of two areas adjacent in a right side, two areas adjacent in a lower side, and one area adjacent in a lower right side, relative to a location of the at least one area.

3. The coding device according to claim 2, wherein a block size of the block is 8×8.

4. The coding device according to claim 2, wherein a coding coefficient of the plurality of coding coefficients is a significance coefficient flag.

5. A method, comprising:
assigning contexts, wherein the assigned contexts are split into:
at least one area for coding by each coding coefficient of a plurality of coding coefficients without sharing a context for each coding coefficient, and
five areas for coding by merging the plurality of coding coefficients with sharing the context for each coding coefficient; and
applying a significance map coding processing to a significance map for coding coefficients of a block based on the assigned contexts.

6. The method according to claim 5, wherein
the at least one area is on an upper left side of the block which is a low frequency region including a DC component, and
the five areas consist of two areas adjacent in a right side, two areas adjacent in a lower side and one area adjacent in a lower right side, relative to a location of the at least one area.

7. The method according to claim 6, wherein a block size of the block is 8×8.

8. The method according to claim 6, wherein a coding coefficient of the plurality of coding coefficients is a significance coefficient flag.
